(19) United States
(12) Patent Application Publication
(10) Pub. No.: US 2005/0267861 A1
(43) Pub. Date: Dec. 1, 2005

(54) Virtual library management system

(76) Inventors: Raymond M. Jassin, Huntington, NY (US); Marjorie Jassin, Huntington, NY (US)

Correspondence Address: Cowan, Liebowitz & Latman, P.C., 1133 Avenue of the Americas, New York, NY, 10036-6799, US

(21) Appl. No.: 11/136,969

(22) Filed: May 25, 2005

Related U.S. Application Data
(60) Provisional application No. 60/574,146, filed on May 25, 2004.

(51) Int. Cl. G06F 7/00

(52) U.S. Cl. 707/1; 707/100

(57) ABSTRACT

The invention provides a virtual library system for use in managing libraries, for example in law firms, by providing needed library services without the need of a library service provider to be physically present at the library premises. The services of a virtual library are provided by a library management team, whose members (library service providers) may readily service multiple clients and libraries from remote locations. The virtual library along with its database is hosted on a server accessible via a network by both the clients and the library service providers from their own computer terminals. In an illustrative embodiment, the virtual library comprises five main modules in order to service clients, namely acquisition requests, interlibrary loan requests, reference help requests, online library shelf list, and library expenses. With each module the client may opt to receive periodic activity reports for increased control of library operations.

### RELATED PATENT APPLICATION

This application is related to U.S. Provisional Patent Application Ser. No. 60/574,146, which was filed on May 25, 2004 and is incorporated herein by reference.

### BACKGROUND OF THE INVENTION

Many public libraries have begun to incorporate technology into their services in order to provide their users with tools for more convenient and efficient use of their services. However, use of technology in libraries is still narrow, and generally limited to enhancing features on the libraries' main web sites.

An article entitled CLEVNET (in the Library Journal published on Sep. 15, 2003) disclosed a virtual library representing an association of 31 libraries spread over nine counties in northern Ohio. CLEVNET focuses on core public library service such as catalog searches, loan requests, renewals, interlibrary loans, as well as research help. Nevertheless, the providers of the service must be resident in the library in order to offer the service, which is only remote for its users.

### BRIEF DESCRIPTION OF THE DRAWINGS

For a better understanding of the invention and further features thereof, reference is made to the following detailed description of the invention to be read in conjunction with the accompanying drawings, wherein:

FIG. 1 is a functional block diagram of a virtual library management system.

FIG. 2 is a flow diagram of various functions (modules) of the virtual library management system.

FIGS. 3A-G are screens downloaded as web pages from the system server through which clients can access the various functions of the system.

FIGS. 3H-L are screens downloaded as web pages from the system server through which the management team can respond to client requests and administer the various functions of the system.

### SUMMARY OF THIS INVENTION

This invention relates to a virtual library system for managing libraries to enable at least one library service provider to provide library services to a plurality of clients without the need of the library service provider to be physically present at the library premises. The library system comprises a database, a server for hosting the database, and a network accessible by both the plurality of clients and the library service provider from a plurality of corresponding computer terminals. The server is programmed to provide a plurality of library service modules. Each computer terminal enables one of the plurality of clients to access the database via a corresponding one of the plurality of computer terminals and the network to the database.

In a further aspect of this invention, the server is programmed to implement at least one of the following modules of services: acquisition requests, interlibrary loan requests, reference help requests, online library shelf list, and library expenses.

In a still further aspect of this invention, each module enables a client to receive periodic activity reports for control of library operations.

### DETAILED DESCRIPTION OF A PREFERRED EMBODIMENT OF THE INVENTION

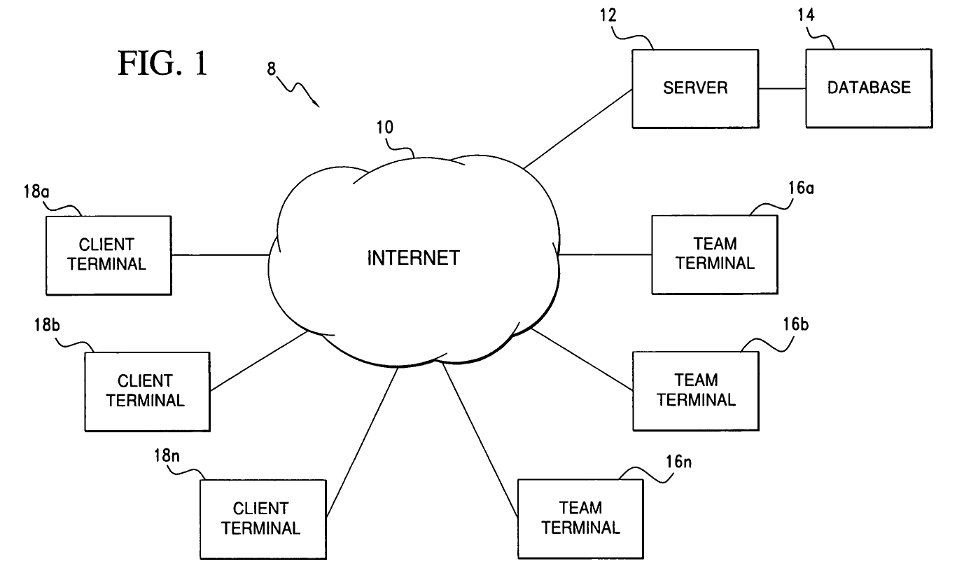

Referring now to the drawings and in particular to FIG. 1, there is shown an illustrative embodiment of a virtual library 8, which may be used to manage libraries, for example in law firms, by providing needed library services without the need of a library service provider to be physically present at the library premises. The services of the virtual library 8 are provided by a library management team, comprising one or a plurality of the library service providers, who may readily service a plurality of clients and a plurality of libraries from remote locations. The virtual library 8 and a database 14 are hosted on a server 12, which is external to a plurality of client terminals 18a-18n and to a plurality of library service provider terminals 16a-16n, and which can be accessed via a network 10 by both the clients and the library service providers. In an illustrative embodiment, the network 10 may take the form of the Internet. Though the library service provider terminals 16a-16n do not need to be disposed close to the library they service, at least one of the client terminals 18a-18n may be disposed in an illustrative embodiment conveniently close to its library to permit the clients close access to its terminal 18 as well as to library materials. In this regard, it is contemplated that the client terminal 18 may be disposed in close access to where its clients work.

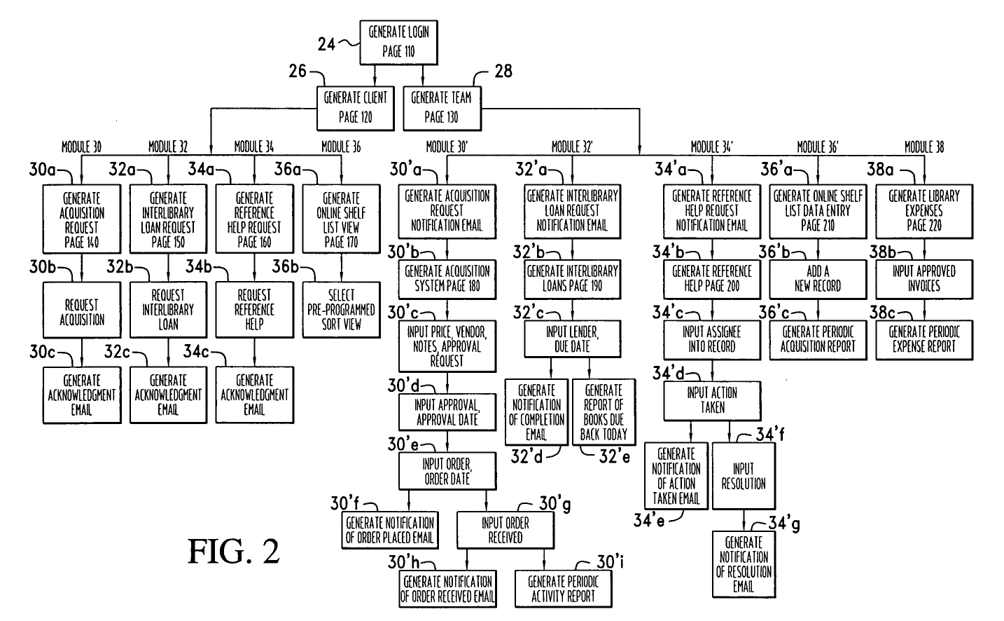

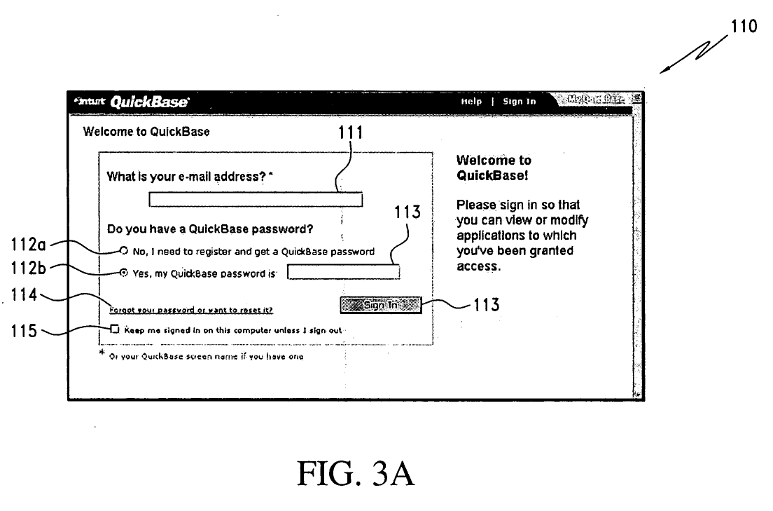

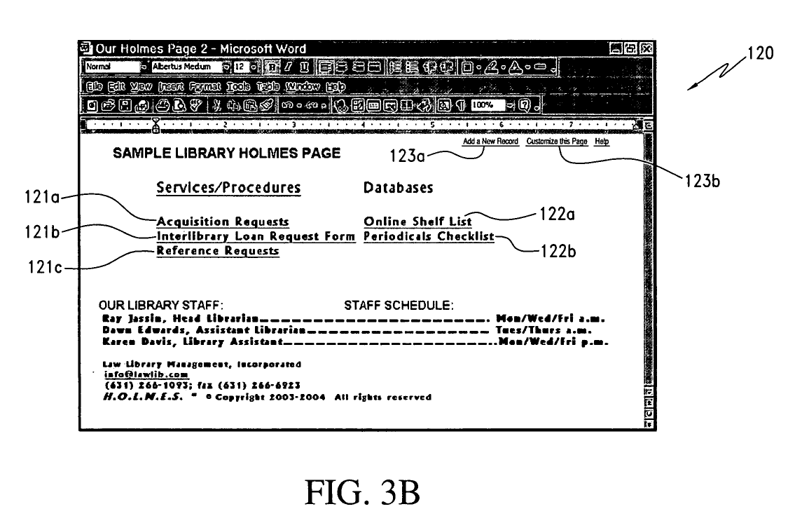

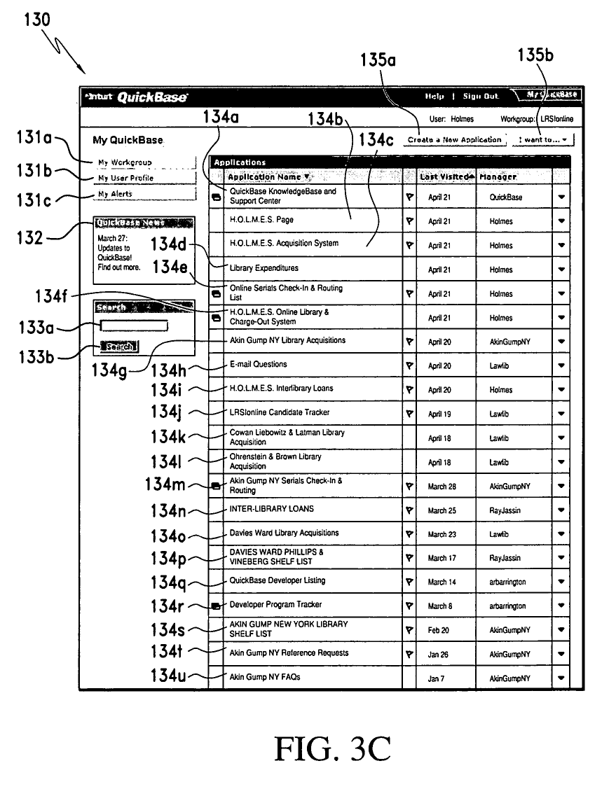

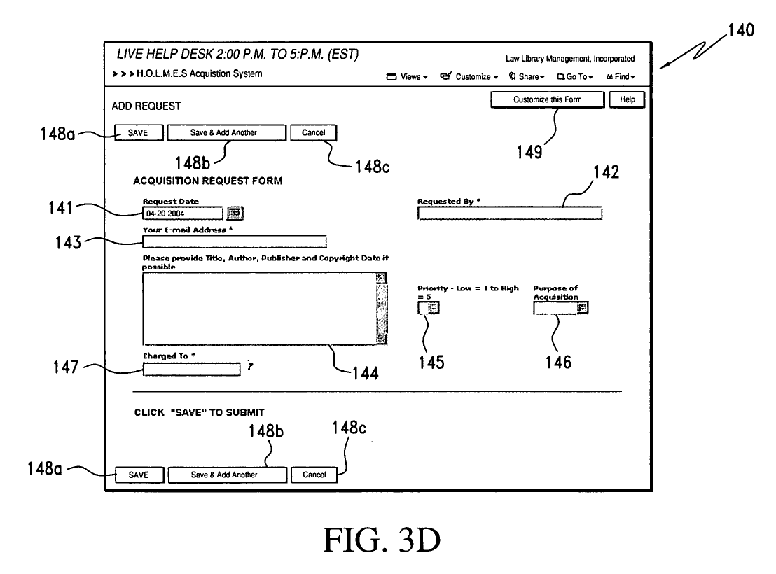

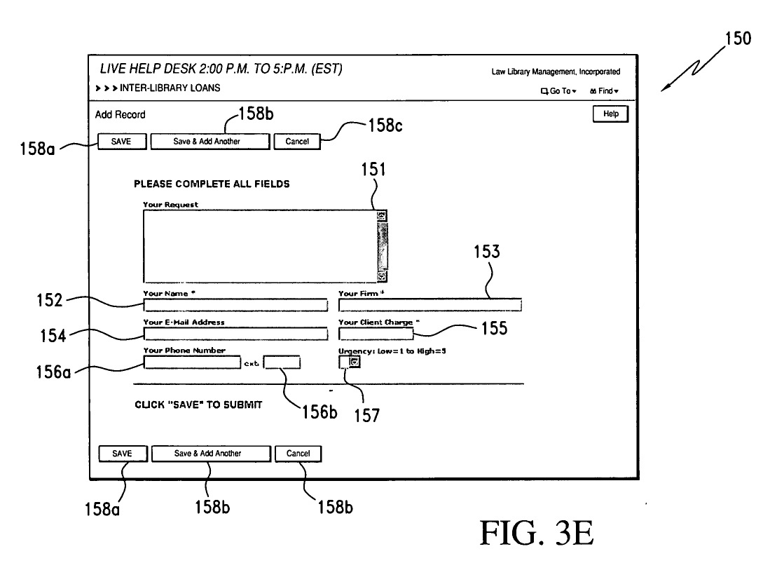

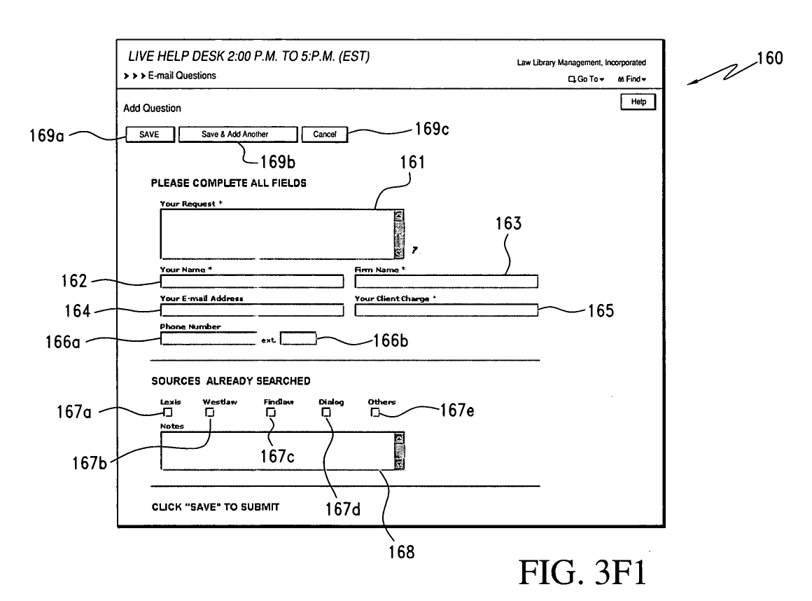

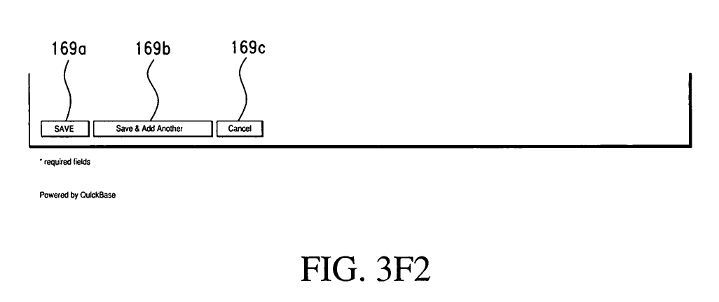

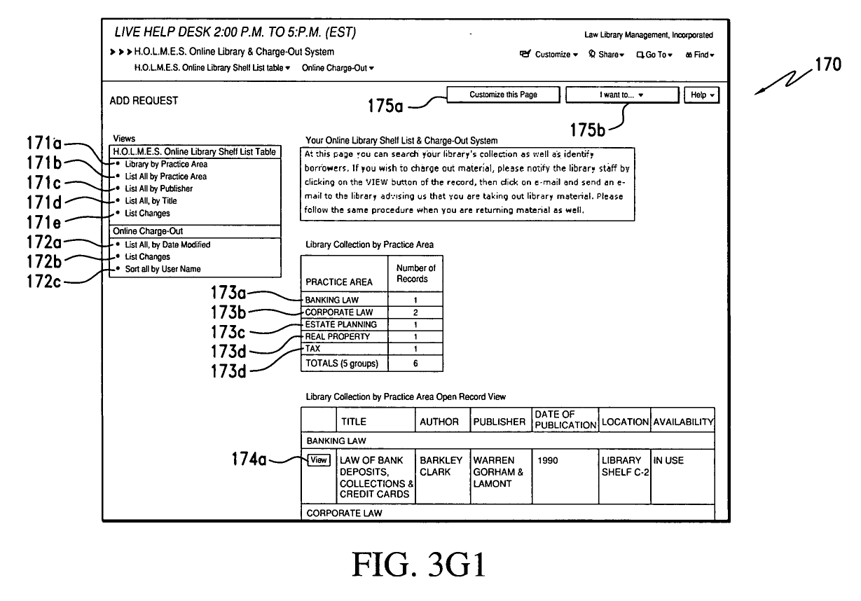

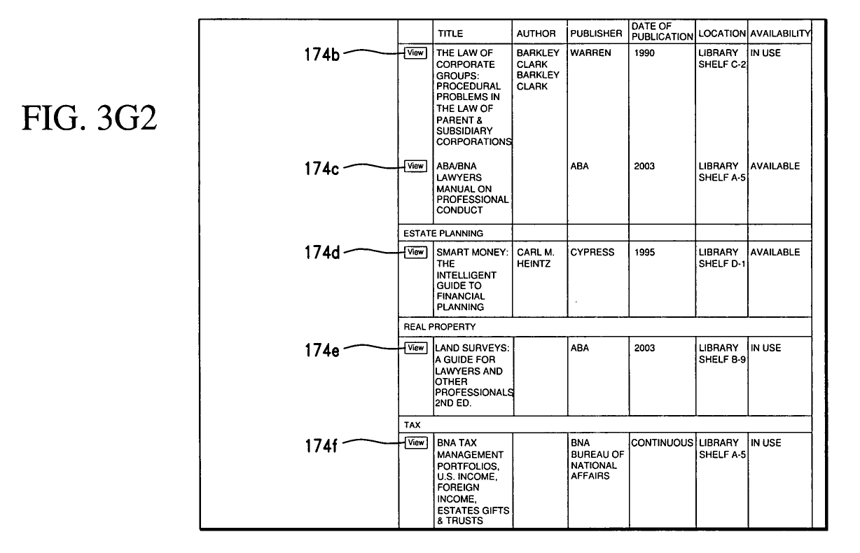

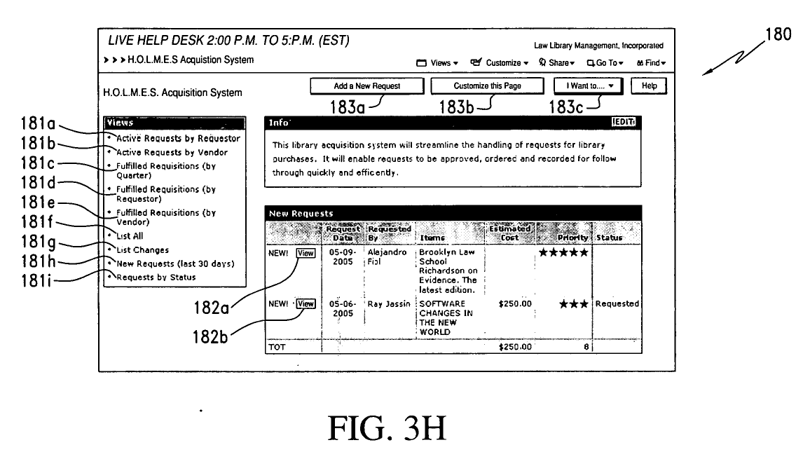

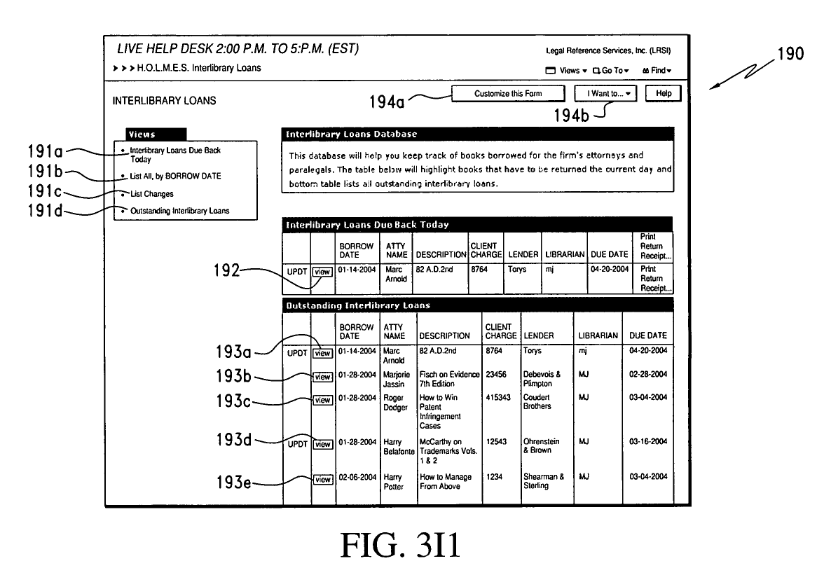

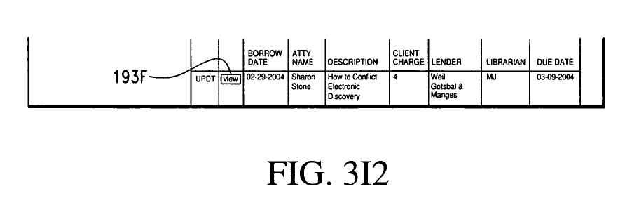

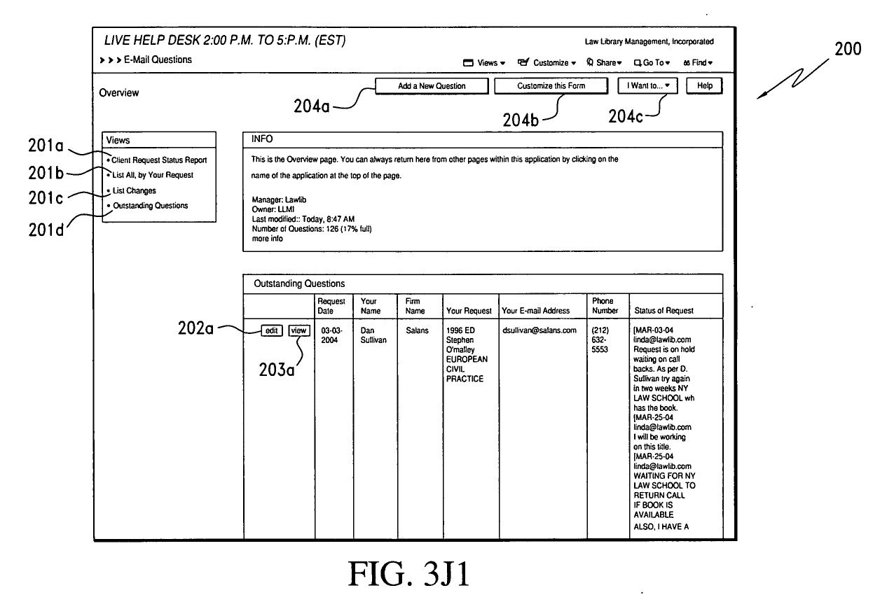

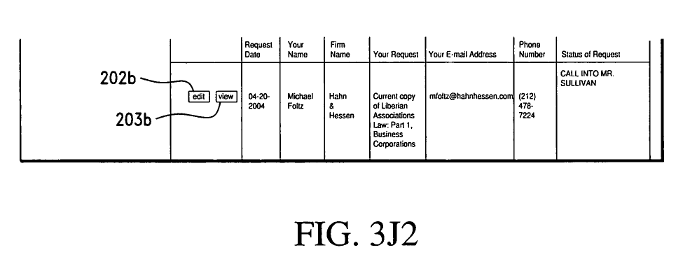

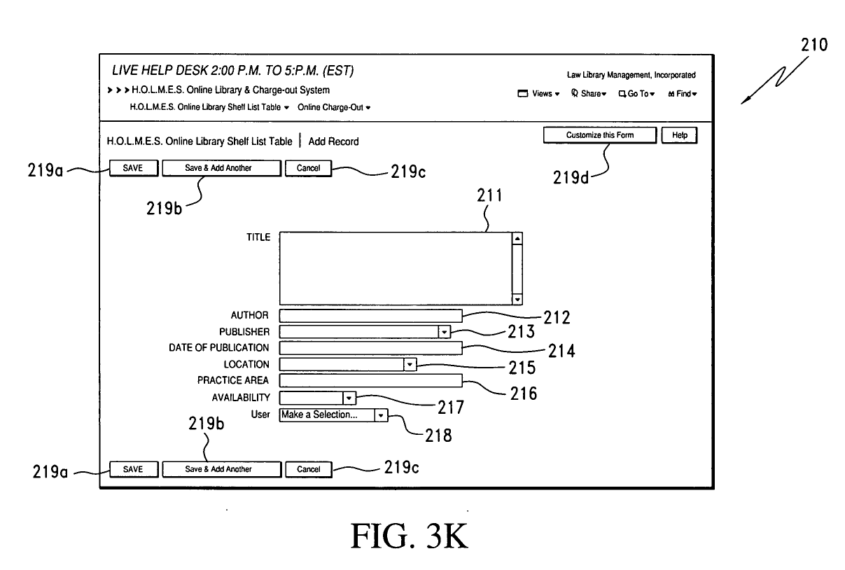

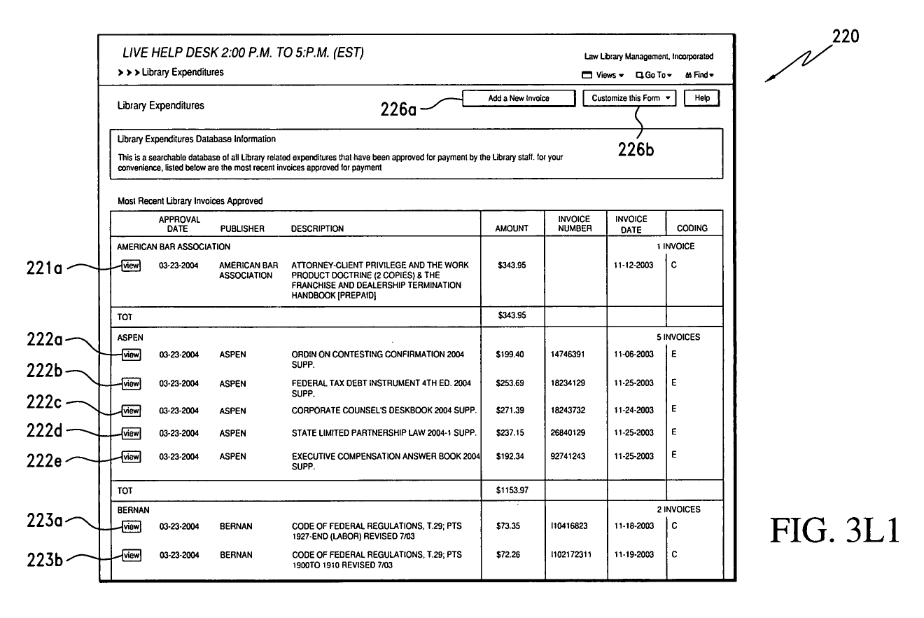

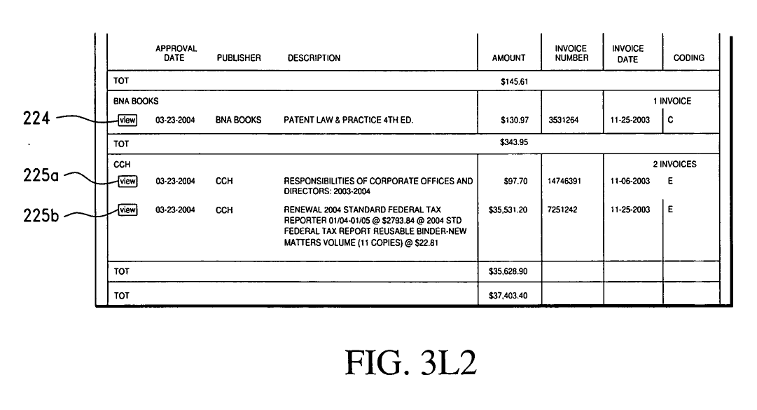

Referring now to the flow chart of FIG. 2, there is shown a method for accessing a library management system 20 for implementing five functions, as will be explained below in detail. Both the client and the library service provider log into the system 20 in step 24, where a common login page 110 is displayed as shown in FIG. 3A. On the login page 110 the client or library service provider is prompted to enter his e-mail address in a data entry field 111 and a password in data entry field 113. Still in step 24, upon clicking the “Sign In” button 116 the entered information is validated and identified as belonging to either an authorized client or a library service provider. If the entered information is identified as belonging to a client, then step 26 displays a client page 120. On the other hand, if the entered information is identified as belonging to a library service provider, step 28 displays a team page 130. From the client page 120, the client may access any one of the four basic functions indicated in FIG. 2 as modules 30, 32, 34 and 36, as will be explained below. From the team page 130, the library service provider administers these functions, indicated in FIG. 2 as modules 30′, 32′, 34′, and 36′, as will be explained below. The library service provider may also manage an additional module 38.

When the client page 120 is displayed in step 26, as shown in FIG. 3B, the client may access any of the following modules: acquisition requests module 30, interlibrary loan requests module 32, reference help requests module 34 and online shelf list view module 36, through one of a plurality of corresponding links 121a-122a. For example, by clicking the ‘Acquisition Requests’ link 121a, the client can access the acquisition requests module 30. By clicking the ‘Interlibrary Loan Request Form’ link 121b, the client can access the interlibrary loan requests module 32. Modules 34 and 36 in FIG. 2 correspond to reference help requests and online shelf list view respectively and can be accessed through links 121c and 122a.

When the team page 130 is displayed in step 28, as shown in FIG. 3C, the library service provider may administer the modules that are accessible to the client as well as perform other services, by clicking on one of a plurality of corresponding inks 134a-u. In an illustrative embodiment, the team page 130 may be specific to each member of the library management team, and the list of available links may depend on the permissions of a particular library service provider. FIG. 3C shows what the team page 130 may look like when accessed by a library service provider with permissions to service several different clients. For example, by clicking one of the links 134g, 134k, 134l or 134o, the library service provider may access the acquisition system module 30′ for one of four different clients, and administer requests made by these clients through module 30. Similarly, clicking one of the links 134p or 134s allows the library service provider to access the online shelf list module 36′ for one of two clients. As shown in FIG. 3C, the library service provider may also access the interlibrary loan request module 32′ through link 134n, the reference help request module 34′ through link 134t, as well as the library expenses module 38 through link 134d.

The function represented by modules 30 and 30′ in FIG. 2 allows the client to request library acquisitions as well as maintain control over all acquisition activity. Once the client selects the acquisition requests module 30 in step 26, an acquisition request page 140 is displayed in step 30a, as shown in FIG. 3D. The acquisition request page 140 comprises a plurality of data entry fields 141-147, where the client may enter information about a desired acquisition. In order to submit a valid request, the client is obliged to complete at least the data entry fields marked with an asterisk, such as ‘Requested By’ 142 that requires the name of the individual requesting the acquisition, ‘Your E-mail Address’ 143 that requires the e-mail address of the individual requesting the acquisition, and ‘Charged To’ 147 that requires the name of the individual or firm that will be charged for the acquisition. The remaining data entry fields provide additional information about the request, such as data entry field 141 where the client may enter the date, data entry field 144 where the client may enter information concerning the title, author, publisher or copyright date, data entry field 145 where the client may rank the priority of the request, and data entry field 146 where the client may enter the purpose of the acquisition request. In step 30b, upon entering the necessary information, the client clicks the ‘Save’ button 148a, which submits the request to the library management team. The client may also click the ‘Save & Add Another’ button 148b, which submits the request to the library management team and displays a new acquisition request page 140. Clicking the ‘Cancel’ button 148c cancels the request and no information is submitted. Once an acquisition request has been made by the client in step 30b, an automatic acknowledgement e-mail is generated in step 30c and sent to the client, confirming that the request has been submitted to the library management team.

Simultaneously in step 30′a, an automatic notification e-mail is generated and sent to the library management team, notifying the team of the request. Depending on the arrangement with a particular client, the notification e-mail may be directed to a designated library service provider, or a library service provider may be designated after the e-mail has been sent to the entire library management team. Once sent, e-mails are stored on the server in memory specially designated for storing transmitted messages until they are received by the library service providers on their terminals. Upon receipt of the notification containing all the information provided by the client, a library service provider accesses an acquisition system page 180 in step 30′b, as shown in FIG. 3H, in order to administer the client's request. The acquisition system page 180 comprises a plurality of links 181a-i, by means of which the library service provider may select a particular view, and links 182a-b, which allow the client to see the details of a particular acquisition request. By selecting one of the links 181a-i, the library service provider may choose to view a list of active acquisition requests sorted by requestor 181a or by vendor 181b, or to view a list of fulfilled acquisition requests sorted by billing quarter 181c, by requestor 181d, or by vendor 181e. The library service provider may also view all the requests, sorted by request date 181f or by status 181i, or view only new requests from the last 30 days 181h. A list of recently modified records may be viewed via link 181g. The acquisition system page 180 displays a list of new acquisition requests, each of which may be viewed in detail upon clicking on one of the corresponding links 182a-b.

To add a new acquisition request, upon receipt of the notification e-mail, the library service provider clicks the ‘Add a New Request’ button 183a on the acquisition system page 180. In step 30′c the library service provider enters into the system the information provided by the client, as well as additional information such as the price of the acquisition, the vendor, and other pertinent details, creating a record of the request. The record is then forwarded to the requesting firm's library supervisor for approval of the request. In step 30′d, upon receipt of the approval for purchase, the library service provider inputs the approval information into the record, namely the name of the supervisor who approved the request and the date of the approval. In step 30′e, the library service provider places the order, followed by step 30′f, where an automatic notification e-mail is generated and sent to the client, giving notice that the order has been placed. Once the material requested by the client is received in step 30′g and a library service provider enters into the record that the order has been received, an automatic notification e-mail is generated in step 30′h to the client, giving notice of the receipt of the order. To provide increased control of library acquisitions, an additional step 30′i may be performed, where a periodic acquisition activity report is generated for the client in the form of an e-mail.

The function represented by modules 32 and 32′ in FIG. 2 allows the client to request interlibrary loans as well as maintain control over all interlibrary loan activity. Once the client selects the interlibrary loans request module in step 26, an interlibrary loan request page 150 is displayed in step 32a, as shown in FIG. 3E. The interlibrary loan request page 150 comprises a plurality of data entry fields 151-157, where the client may enter information about a desired interlibrary loan. In order to submit a valid request, the client is obliged to complete at least the data entry fields marked with an asterisk, such as ‘Your Name’ 152 that requires the name of the individual making the request, ‘Your Firm’ 153 that requires the name of the firm that the individual making the request works for, and ‘Your Client Charge’ 155 that specifies the amount that should be charged for the service. The remaining data entry fields provide additional information about the request, such as data entry field 151 where the client may enter details pertaining to the request, data entry field 154 where the client may enter his e-mail address, data entry fields 156a and 156b where the client may enter his phone number, and data entry field 157 where the client may rank the urgency of the request. In step 32b, upon entering the necessary information, the client clicks the ‘Save’ button 158a, which submits the request to the library management team. The client may also click the ‘Save & Add Another’ button 158b, which submits the request to the library management team and displays a new interlibrary loan request page 150. Clicking the ‘Cancel’ button 158c cancels the request and no information is submitted. Once an interlibrary loan request has been made by the client in step 32b, an automatic acknowledgement e-mail is generated in step 30c and sent to the client, confirming that the request has been submitted to the library management team.

Simultaneously in step 32′a, an automatic notification e-mail is generated and sent to the library management team, notifying the team of the request. Due to the time sensitive nature of the interlibrary loan request, the notification e-mail may also be sent to the cellular phones of the library management team members in the form of a text message. Upon receipt of the notification containing all the information provided by the client, a library service provider accesses an interlibrary loans page 190 in step 32′b in order to administer the client's request, as shown in FIGS. 3I₁-I₂. The interlibrary loans page 190 comprises a plurality of links 191a-d, by means of which the library service provider may select a particular view, and links 192-193f, which provide details of particular interlibrary loans. By selecting one of the links 191a-d, the library service provider may choose to view a list of interlibrary loans due back today 191a, or to sort a list of all interlibrary loans by borrow date 191b. The library service provider may also view outstanding interlibrary loans via link 191d. A list of recently modified records may be viewed via link 191c. The interlibrary loans page 190 displays a list of loans due back on the current day, as well as outstanding interlibrary loans. Details pertaining to any of the displayed loans may be viewed via their corresponding links 192-193f.

To add a new interlibrary loan, upon receipt of the notification e-mail, the library service provider clicks the ‘Add a New Loan’ button 194a on the acquisition system page 190. In step 32′c the library service provider enters into the system the information provided by the client, as well as additional information such as the due date. In step 32′d an automatic notification email is generated and sent to the client, giving notice that the request has been processed. To provide increased control of interlibrary loans, a daily report is generated in step 32′e informing of all books due back on that day.

The function represented by modules 34 and 34′ in FIG. 2 allows the client to request reference help. Once the client selects the reference help request function in step 26, a reference help request page 160 is displayed in step 34a, as shown in FIGS. 3F₁-F₂. The reference help request page 160 comprises a plurality of data entry fields 161-168, where the client may enter information about their request. In order to submit a valid request, the client is obliged to complete at least the data entry fields marked with an asterisk, such as ‘Your Request’ 161 that requires details pertaining to the client's request, ‘Your Name’ 162 that requires the name of the individual requesting reference help, ‘Firm Name’ 163 that requires the name of the firm that the individual making the request works for, and ‘Your Client Charge’ 165 that specifies the amount that should be charged for the service. The remaining data entry fields provide additional information about the request, such as data entry field 164 where the client may enter his e-mail address, data entry fields 166a-b where the client may enter his phone number, data entry fields 167a-e where the client may identify the sources already searched, and data entry field 168 where the client may enter any other details pertaining to the request. In step 34b, upon entering the necessary information, the client clicks the ‘Save’ button 169a, which submits the request to the library management team. The client may also click the ‘Save & Add Another’ button 169b, which submits the request to the library management team and displays a new reference help request page 160. Clicking the ‘Cancel’ button 169c cancels the request and no information is submitted. Once a reference help request has been made by the client in step 34b, an automatic acknowledgement e-mail is generated in step 34c and sent to the client, confirming that the request has been submitted to the library management team.

Simultaneously in step 34′a, an automatic notification e-mail is generated and sent to the library management team, notifying the team of the request. Due to the time sensitive nature of the reference help request, the notification e-mail may also be sent to the cellular phones of the library management team members in the form of a text message. Upon receipt of the notification containing all the information provided by the client, a library service provider accesses a reference help page 200 in step 34′b in order to administer the client's request, as shown in FIGS. 3J₁-J₂. The reference help page 200 comprises a plurality of links 201a-d, by means of which the library service provider may select a particular view, and links 202a-203b, which provide the option of viewing or editing details of particular reference help requests. By selecting one of the links 201a-d, the library service provider may choose to view a client status report 201a, a list of all reference help requests sorted by request 201b, or a list of outstanding questions 201d. A list of recently modified records may be viewed via link 201c. The reference help page 200 displays a list of outstanding questions from clients, each of which may be viewed in detail by clicking on one of the corresponding links 203a-203b. Each reference help request may also be edited by a library service provider by clicking on one of the corresponding links 202a-b.

To add a new reference help request, upon receipt of the notification e-mail, the library service provider clicks the ‘Add a New Question’ button 204a on the reference help page 200. In step 34′c the library service provider enters into the system the information provided by the client, creating a record of the request, and assigns a member of the library management team to assist the client. In step 34′d the library service provider inputs the action taken into the record and an automatic e-mail is generated and sent to the client in step 34′e, giving notice that the action has been taken. Upon receiving the request, the assigned library service provider inputs the resolution to the request into the record, which generates an automatic notification e-mail in step 34′g that is sent to the client, giving notice of the resolution to the reference help request.

The function represented by modules 36 and 36′ in FIG. 2 allows the client to view an online list of their library's collection. In an illustrative embodiment, this module may also be used to charge-out material and track the location of charged-out items. Once the client selects the online shelf list function in step 26, an online shelf list view page 170 is displayed in step 36a, as shown in FIGS. 3G₁-G₂. The online shelf list view page 170 comprises a plurality of links 171a-172c, which the client may select in step 36b in order to view information in a particular category, sort information by a particular feature or view items charged out by other firm employees. The client may choose a particular practice area by selecting link 171a, or choose to view the library's entire collection sorted by either practice area via link 171b, by publisher via link 171c, or by title via link 171d. The client may also choose to view recently modified records by selecting 171e. A list of all items charged out, sorted by the date, may be accessed via link 172a, or via link 172c sorted by the user name. Recent changes to the charge-out system may be viewed by selecting link 172b. The online shelf list view page 170 in FIGS. 3G₁-G₂ shows what an example of what a client may see upon selecting to view the library by practice area via link 171a. The client may choose a practice area from the list comprising links 173a-e. Below on page 170 is a detailed list of library records sorted by practice area. By selecting any of the links 174a-f the client may view the details of the selected record.

In order to administer the online shelf list module 36′, a library service provider accesses an online shelf list data entry page 210 in step 36′a, as shown in FIG. 3K. The online shelf list data entry page 210 comprises a plurality of data entry fields 211-218, where the library service provider may enter information pertaining to the new record, such as title 211, author 212, publisher 213, date of publication 214, location 215, practice area 216, availability 217 and user 218. Upon entering the necessary information, the library service provider clicks the ‘Save’ button 219a, which updates the system by adding the new record to the online shelf list. The library service provider may also click the ‘Save & Add Another’ button 219b, which updates the system by adding the new record to the online shelf list and displays a new online library add record page 210. Clicking the ‘Cancel’ button 219c cancels the action and the system is not updated. To provide increased control of library activity, an additional step 36′c may be performed where a periodic report of books added to the library, sorted by practice area, is generated for the client in the form of an e-mail.

The function represented by module 38 in FIG. 2 allows library service providers to manage the library's expenses. Once the library service provider selects the library expenses function in step 28, the library expenditures page 220 is displayed in step 38a, as shown in FIGS. 3L₁-L₂. The library expenditures page 220 comprises a list of the most recent approved invoices, which the library service provider may view in detail via a plurality of links 221a-225b. In step 38b the library service provider may add a new improved invoice to the list by clicking the ‘Add a New Invoice’ link 226a on page 220. A periodic expenses report is generated in step 38c and sent to the client.

In an illustrative embodiment of this invention, an online method manages the demands for information placed on the library and library staff by the legal and administrative personnel of a law firm. This online method leverages the efficiency and reach of the internet by providing systems and personnel which can be accessed by firms on an as-need basis. Rather than having to purchase and install software as well as store library data on their own servers, this system and the data gathered and stored by it, are hosted and backed up daily, elsewhere. This frees the firm from conflicts with other software resident on their own servers as well as storage issues.

The online method also streamlines the service functions of the library staff by automatically communicating actions taken on requests for information to the requester when library personnel enter data into the record tracking the request. This eliminates the task of routine communication and follow through required for good service as well as documents the request from beginning to end for future reference.

This system also supports a dramatic reduction of personnel costs by offering firms an alternative to staffing libraries with physically present personnel. Rather, an as-need model of accessing ever present remote personnel through low cost web-based software, will greatly reduce the overall cost of managing the information needs of the firm. In addition, this system supports to true collaboration of client and outside service by including personnel from both as a team behind the system providing the service to the firm.

In one illustrative embodiment of this invention, the system comprises a plurality of modules that perform a certain function, i.e., the Interlibrary Loan module tracks books that are borrowed; the Acquisition System tracks books that are ordered for purchase, etc. The Shelf List module documents ownership and location of library material owned by the firm. The system may be selectively customized for each client as to how many modules they will need to manage their library efficiently as well as how each module will be linked to others.

The system provides a turnkey software and service solution to manage law firm libraries that requires internet access only. Through a simple login screen, law firms will now have access to their library systems, content and staff anywhere and anytime through the web.

1. A virtual library system for managing libraries to enable at least one library service provider to selectively provide library services to a plurality of clients without the need of the library service provider to be physically present at the library premises, said library system comprising:
a. database;
b. a server for hosting the database;
c. a network accessible by both the plurality of clients and the library service provider from a plurality of corresponding computer terminals;
d. said server being programmed to provide a plurality of library service modules; and
e. each computer terminal enabling one of the plurality of clients to access said database via a corresponding one of said plurality of computer terminals and said network to said database

2. The virtual library system as claimed in claim 1, wherein said server is programmed to implement at least one of the following modules of services: acquisition requests, interlibrary loan requests, reference help requests, online library shelf list, and library expenses.

3. The virtual library system as claimed in claim 2, each module enables a client to receive periodic activity reports for control of library operations.
